(19) United States
(12) Patent Application Publication
(10) Pub. No.: US 2004/0052077 A1
(43) Pub. Date: Mar. 18, 2004

(54) Light emitting diode with integrated heat dissipater

(76) Inventor: Kelvin Shih, Brighton, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/641,759

(22) Filed: Aug. 14, 2003

Related U.S. Application Data
(63) Continuation of application No. 09/963,101, filed on Sep. 25, 2001.

(51) Int. Cl. F21V 29/00

(52) U.S. Cl. 362/294; 362/800

(57) ABSTRACT

A light emitting diode (LED)has an integrated heat sink structure for removing heat from an LED junction and for dissipating heat from the junction to the ambient air. The anode and the cathode both either act as or are coupled to a thermally conductive material which acts as the heat sink. In one embodiment, the heat sink forms a mounting configuration that allows air to circulate around multiple surfaces to maximize heat dissipation. As a result, the LED junction temperature remains low, allowing the LED to by driven with higher currents and generate a higher light output without adverse temperature-related effects.

### TECHNICAL FIELD

This invention relates to light emitting diodes, and more particularly to a light emitting diode having a thermally conductive structure for dissipating heat.

### BACKGROUND OF THE INVENTION

Light emitting diodes (LEDs) have been available since the early 1960's. Because of the relatively high efficiency of LEDs, LEDs are increasingly popular in a wider variety of applications, such as interior and exterior automobile lighting, traffic lights, outdoor signs, and other applications not considered practical in the past.

Even with new high-temperature LED technology, however, LEDs still exhibit a substantial decrease in light output when the temperature of the LED junction increases due to high current conditions. For commonly-used LEDs having a high thermal resistance, the relative flux decreases if the forward current increases beyond a certain point. For example, an increase of 75 degrees Celsius in the LED junction temperature may cause the luminous flux level to be reduced to one-half of its room temperature value. This phenomenon limits the amount of output from conventional LEDs.

There have attempts to reduce the thermal resistance of the LEDs in order to effectively conduct the heat to an external heat sink, allowing heat to dissipate through the heat sink into the ambient air. For example, U.S. Pat. No. 5,857,767 to Hochstein teaches mounting LEDs to a heat sink with electrically and thermally conductive epoxy. This structure does allow LEDs to be driven with higher currents than conventional printed circuit board assemblies while still maintaining a relatively low LED junction temperatures, thereby allowing increased light output. However, few LEDs are compatible with the Hochstein structure because most LEDs use a lead frame, which has a small surface area, to support the LED chip as well as to make electrical connections. The lead frame structure requires any heat in the cathode of the LED to conduct through long, narrow legs, making it difficult to remove any significant heat from the LED junction. This lack of surface area makes efficient heat dissipation to the ambient air difficult, if not impossible.

There is a need for a LED structure that can quickly remove heat from the LED junction as well as dissipate heat quickly to the ambient air.

### SUMMARY OF THE INVENTION

Accordingly, the present invention is directed to a light emitting diode, comprising an anode, a thermally conductive cathode that is electrically isolated from the anode, a light-emitting diode chip disposed on the cathode and electrically coupled to the anode, and a heat sink individually associated with the light emitting diode and integrally coupled to at least one of the anode and the cathode.

The invention is also directed to a printed circuit board having a top surface and a bottom surface, comprising at least one light emitting diode having an anode, a thermally conductive cathode that is electrically isolated from the anode, a light-emitting diode chip disposed on the cathode and electrically coupled to the anode, a heat sink individually associated with the light emitting diode and integrally coupled to at least one of the anode and the cathode, a lens covering the light-emitting diode chip, and an electrical connection between said at least one light emitting diode and the printed circuit board.

### BRIEF DESCRIPTION OF THE DRAWINGS

FIG. 1A is a top view of a first embodiment of the present invention;

FIG. 1B is a front sectional view of the embodiment shown in FIG. 1A;

FIG. 2A is a top view of a second embodiment of the present invention;

FIG. 2B is a front sectional view of the embodiment shown in FIG. 2A;

FIG. 3A is a top view of a third embodiment of the present invention before being connected to a system heat sink;

FIG. 3B is a front sectional view of the embodiment shown in FIG. 3A after being connected to a system heat sink;

FIG. 3C is a side sectional view of the embodiment shown in FIG. 3A after being connected to a printed circuit board;

FIG. 3D is a side sectional view of the embodiment shown in FIG. 3A after being connected to a printed circuit board in an alternative manner;

FIG. 4A is a top view of a fourth embodiment of the present invention;

FIG. 4B is a front sectional view of the embodiment shown in FIG. 4A;

FIG. 4C is a front sectional view of the embodiment shown in FIG. 4A after being connected to a printed circuit board.

FIG. 5A is a top view of a fifth embodiment of the present invention;

FIG. 5B is a front sectional view of the embodiment shown in FIG. 5A;

FIG. 5C is a front sectional view of the embodiment shown in FIG. 5A after being coupled to an external heat sink;

FIG. 5D is a front sectional view of the embodiment shown in FIG. 5A after being coupled with a printed circuit board;

FIG. 5E is a front sectional view of the embodiment shown in FIG. 5A when used when coupled with a printed circuit board in an alternative manner.

### DETAILED DESCRIPTION OF THE DRAWINGS

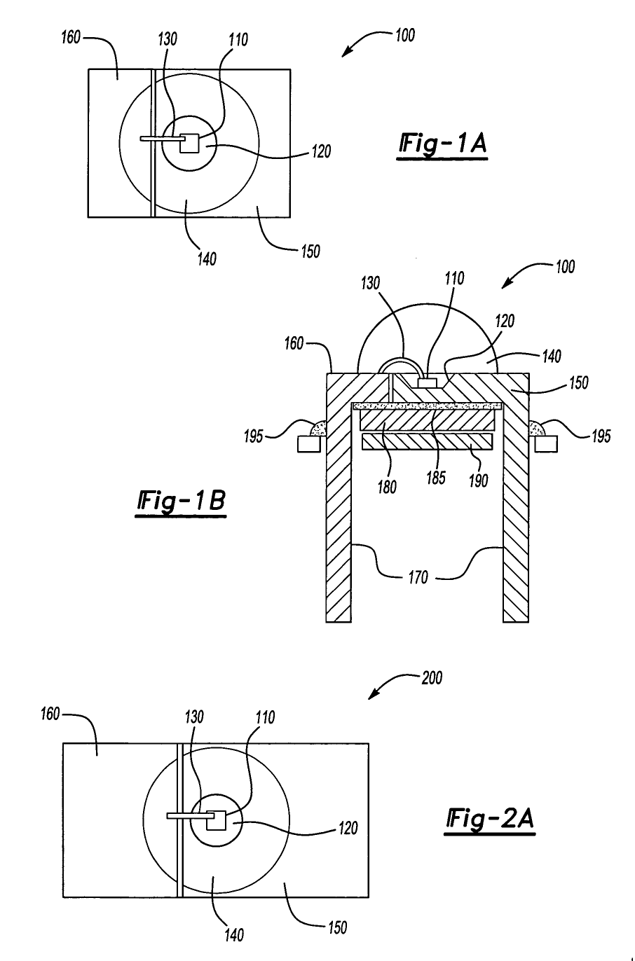

FIG. 1A and 1B are top and front sectional views, respectively, of one embodiment of an LED structure 100 according to the present invention, A cathode 150 and anode 160 in the LED structure are made from strips of thermally conductive material, such as copper, aluminum or another similar material. The anode 160 and cathode 150 strips are disposed next to each other and are held together in any known manner that allows the anode 150 and cathode 160 to be electrically isolated from each other, such as non-conductive adhesive or optical epoxy used to form the LED body.

In this embodiment, a reflector cup 120 is machined in the cathode 150 to hold an LED chip 110. A bound wire 130 electrically couples the LED chip 110 to the anode 160. A lens 140 covers the LED chip 110 and the bound wire 130 for protection and for directing light output from the LED chip 110 to the outside environment.

The anode 160 and cathode 150 each have a heat sink portion 170 that can be bent and inserted through openings in a printed circuit board 190 to extend below the bottom surface of the board 190. Conductive adhesive 190 electrically connects the LED structure to the printed circuit board 190.

In the specific embodiment shown in FIGS. 1A and 1B, the anode 150 and cathode 160 are also held together by an optional heat equalizer 180. The heat equalizer 180 can be made from any thermally conductive material and can be the same material as the anode 160 and cathode 150. The heat equalizer 180 is connected to the anode 160 and cathode 150 with electrically non-conductive adhesive 185. Because much of the LED's heat is generated at the cathode 150, the heat equalizer 180 absorbs the heat from the cathode 160 and transfers it to the anode 160 heat sink to distribute heat evenly between the two heat sink portions 170. Note that by allowing the heat sink 170 to extend below the bottom surface of the printed circuit board 170 rather than simply pressing the heat sink 170 flat against the printed circuit board 170 surface, both surfaces of the heat sink 170 are exposed to the ambient air, increasing the surface area through which heat can dissipate.

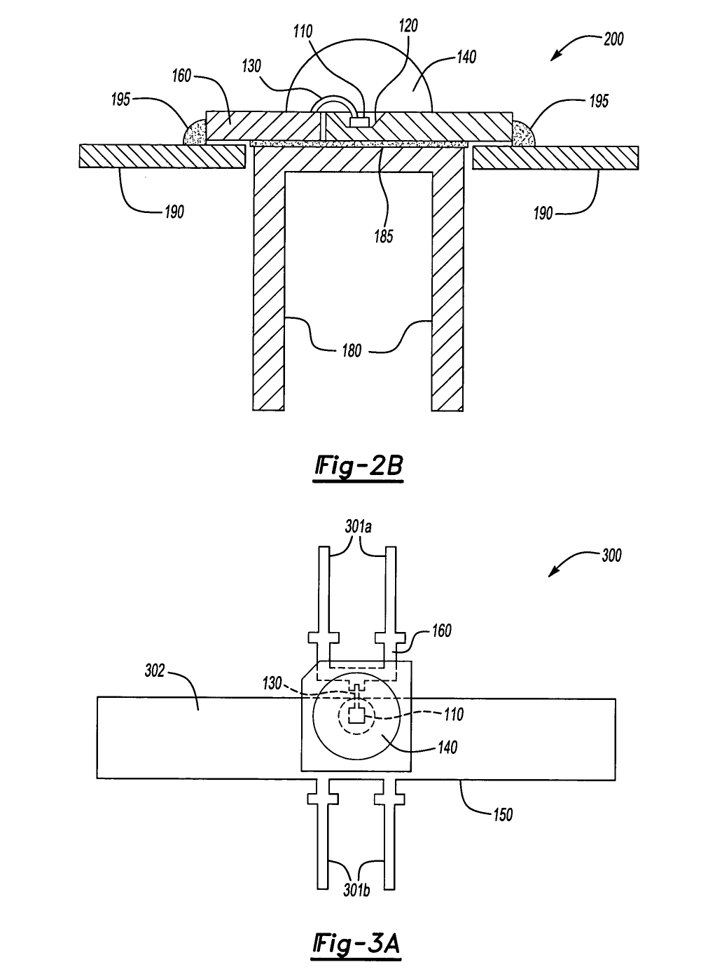

FIG. 2A and 2B are top and front sectional views, respectively, of an alternative LED structure 200 according to the present invention. In this embodiment, the heat equalizer 185 is a thermally conductive strip having portions, much like the heat sink portions 170 described above, that extend through an opening in the printed circuit board 190. The anode 160 and cathode 150 are formed as planar members connected to and supported by the top surface of the printed circuit board 190. Conductive adhesive 195 provides the electrical connection between the LED 200 and the printed circuit board 190.

In this embodiment, the heat equalizer 185 acts as the primary heat dissipater and is not electrically connected either to the anode 160 or the cathode 150. Similar to the embodiment in FIGS. 1A and 1B, the bent portions of the heat equalizer 185 in FIGS. 2A and 2B allow air to circulate around both surfaces of the heat equalizer 185, improving heat dissipation.

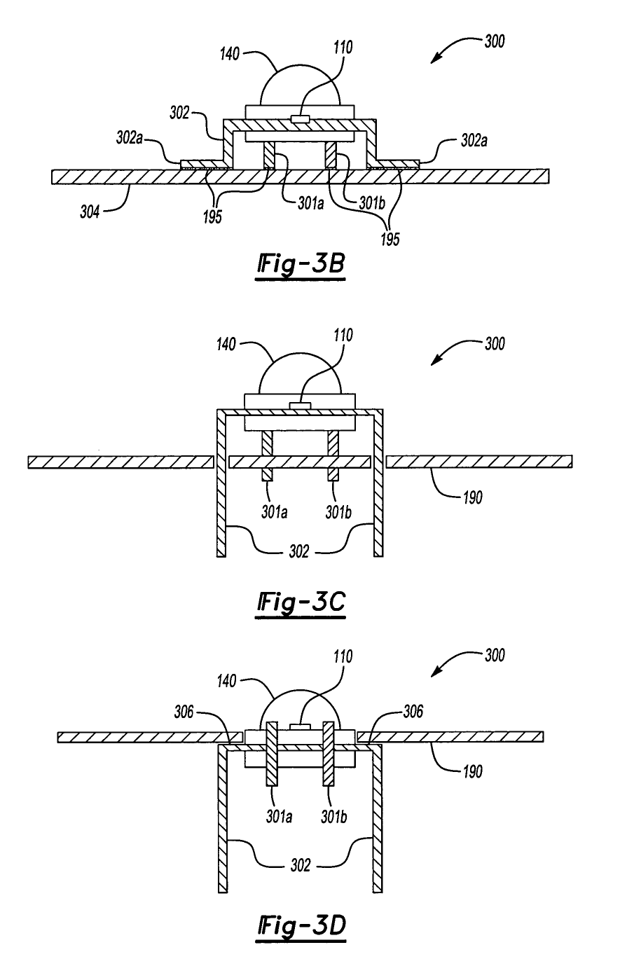

FIG. 3A and 3B are top and front sectional views, respectively, of yet another alternative LED structure 300 according to the present invention. In this embodiment, the anode 160 and cathode 150 have narrow electrically conductive leads 301a, 301b. The cathode 150 also includes a comparatively large extension portion 302 that acts as a heat sink. The extension portion 302 is formed as part of the cathode 150 because the cathode generates most of the LED's heat, as noted above.

Providing narrow leads 301a, 301b along with an extension portion 302 having a large surface area combines the convenience of soldering high thermal resistance leads 301a, 301b with high heat dissipation through the extension 302. More particularly, the high thermal resistance of the leads 301a, 301b, because of their small cross-sectional areas, prevent the LED chip 110 from thermal damage during the soldering process. This high thermal resistance, however, also prevents effective heat dissipation. The extension 302 solves this problem by providing a large surface area through which heat can dissipate. Thus, this embodiment provides separate structures for heat dissipation and for electrical connection.

FIGS. 3B through 3D illustrate various ways in which the LED structure 300 of FIG. 3A can be coupled to the printed circuit board 190. FIG. 3B shows a structure where the extension 302 is bent to form foot portions 302a that can be coupled to a system heat sink 304. The system heat sink 304 can be designed for coupling to another board or can even have an insulating coating and an electrical circuit printed directly on the heat sink 304.

FIG. 3C shows an alternative connection structure where the extension 302 is bent and then inserted through openings in the printed circuit board 190 so that they extend below the bottom surface of the board 190. The connection shown in FIG. 3D also allows portions of the extension 302 to extend below the board 190, but in this embodiment the LED structure is inserted from underneath the board 190 so that a portion 306 of the extension mates with the bottom surface of the printed circuit board 190 while the lens 140 extends through an opening in the board 190. This embodiment also allows the extension 302 to extend below the board 190 and expose a large surface area to the ambient air.

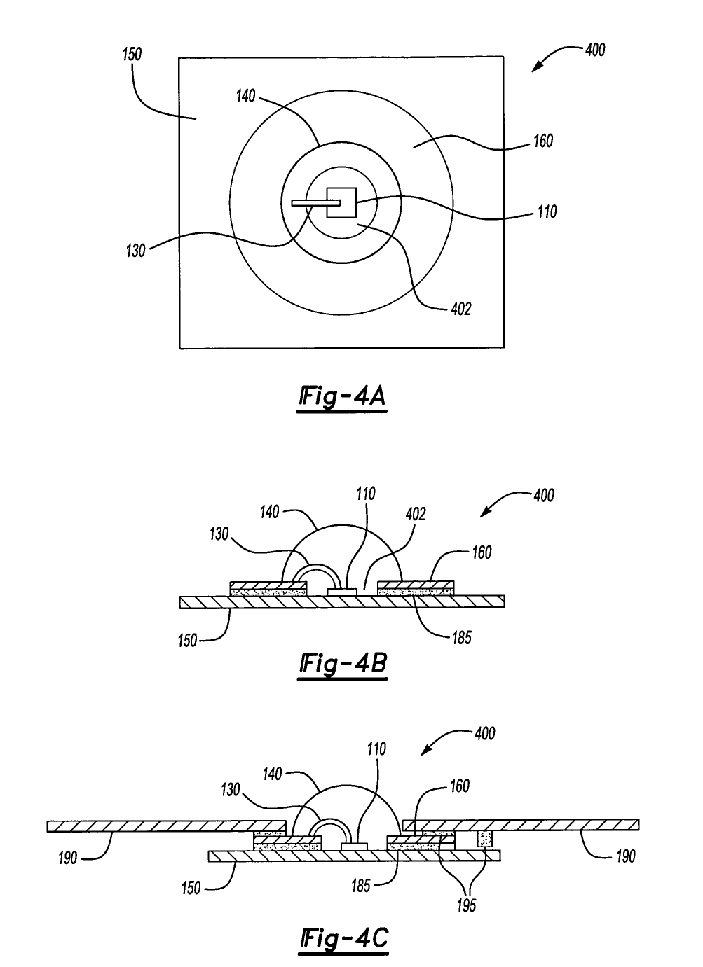

FIG. 4A and 4B are top and front sectional views, respectively, of another LED structure 400 according to the present invention. In this structure, the anode 160 is ring-shaped and connected to the cathode 150 with a non-conductive adhesive layer 185. The cathode 150 in this embodiment is a flat conductive plate. The anode 160 has an opening 402 that surrounds the LED chip 110. Similar to other embodiments, the cathode 150 in this embodiment also acts as a heat sink.

FIG. 4C illustrates one way in which the embodiment shown in FIGS. 4A and 4B can be connected to a printed circuit board 190. In this embodiment, the anode 160 is coupled to the bottom surface of the printed circuit board 190 with a conductive adhesive 195 to form the electrical connection. The lens 140 extends through an opening in the printed circuit board 190.

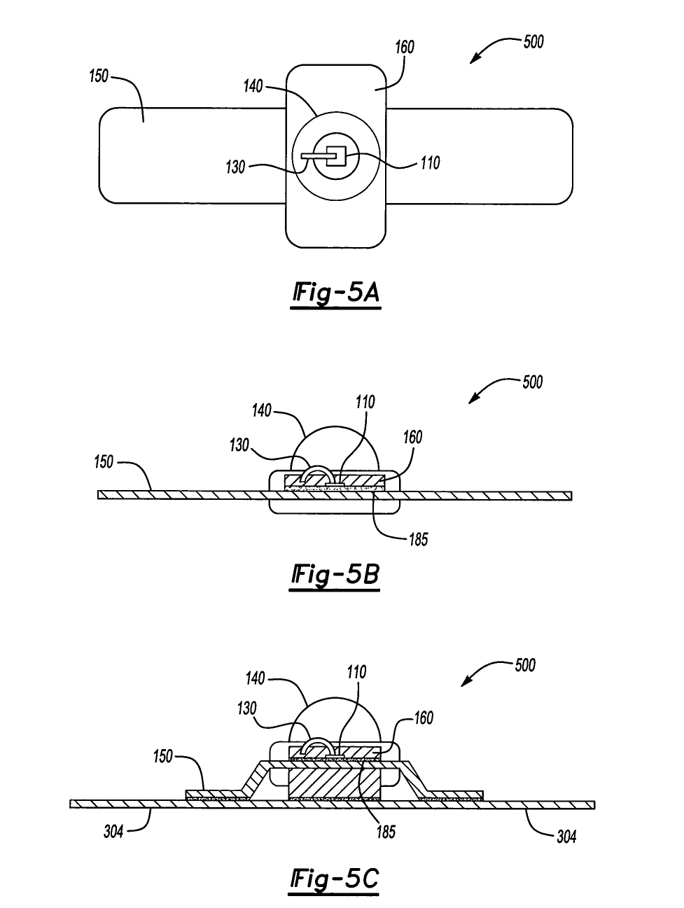

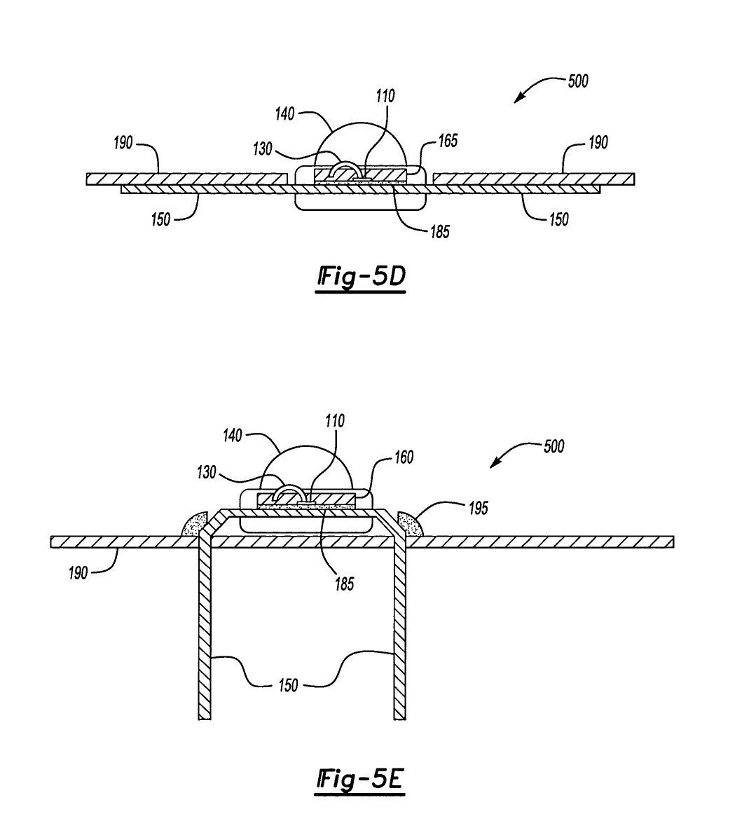

FIG. 5A and 5B are top and front sectional views, respectively, of yet another alternative LED structure 500 according to the present invention. In this embodiment, the anode 150 is a planar conductive plate having an opening 502 for accommodating the LED chip 110. The cathode 160 is formed as a substantially flat, thermally conductive plate to provide additional surface area for heat dissipation, allowing the cathode 160 to be used as a heat sink. The high thermal conductivity of the structure shown in FIGS. 5A and 5B makes soldering less appropriate than electrically conductive adhesive for attaching the LED to the printed circuit board.

FIG. 5C shows the LED structure attached to the system heat sink 304 with an electrically and thermally conductive adhesive. As noted above, the system heat sink 304 may have an insulating coating and an electrical circuit printed on its surface.

FIGS. 5D and 5E show two ways in which the LED of FIGS. 5A and 5B can be connected directly to the printed circuit board 190. In FIG. 5D, the top surface of the cathode 150 is coupled to the bottom surface of the printed circuit board 190 so that the lens 140 can extend upwardly through an opening in the printed circuit board 190. In this embodiment, all electrical connections are preferably on the bottom surface of the board 190. Heat then dissipates through the bottom surface of the cathode 150. The relatively large surface area of the cathode 150 ensures that heat can be dissipated to the ambient air quickly.

FIG. 5E shows an alternative mounting structure where the cathode 150 is bent and inserted through openings in the printed circuit board 190, allowing the ends of the cathode 150 to extend below the bottom board surface while arranging the anode 160 and LED 110 on the top board surface. The LED is connected to the board 190 with conductive adhesive 195. In this configuration, air can circulate around both sides of the cathode 150, increasing the heat dissipation surface area.

As a result, the invention integrates a heat sink into an LED structure to allow efficient heat dissipation from the LED into the ambient air. More particularly, the inventive structure creates an LED having a large cross-sectional area and a direct path between the LED chip and the heat sink, increasing the efficiency in which heat is removed from the LED chip. The efficient heat dissipating properties of the inventive LED structure allows the LED junction temperature to be kept low even as the forward current through the LED chip is increased to increase the light output. As a result, the inventive LED structure allows the LED to be driven with a much higher current than previously thought possible, allowing increased overall light output per LED. Further, the inventive structure preserves efficient heat dissipation even when the LED is mounted on a printed circuit board, eliminating the need for an external heat sink.

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. A light emitting diode, comprising:
an anode;
a thermally conductive cathode, wherein the anode and the cathode are electrically isolated from each other;
a light-emitting diode chip disposed on the cathode and electrically coupled to the anode; and
a heat sink individually associated with the light emitting diode and integrally coupled to at least one of the anode and the cathode.

2. The light emitting diode of claim 1, wherein at least one of the anode and the cathode is made from a thermally and electrically conductive strip that acts as both a thermal and electrical connector.

3. The light emitting diode of claim 2, wherein the electrically conductive strip is bent to extend through an opening in a printed circuit board.

4. The light emitting diode of claim 1, further comprising a heat equalizer coupled to the anode and the cathode.

5. The light emitting diode of claim 4, wherein the heat equalizer is made from a thermally conductive strip.

6. The light emitting diode of claim 5, wherein the anode and the cathode are planar and wherein the thermally conductive strip forming the heat equalizer is bent to extend below a bottom surface of a printed circuit board.

7. The light emitting diode of claim 1, wherein the cathode has a lead portion and an extension portion, wherein the lead portion is constructed for soldering to a printed circuit board and wherein the extension portion acts as a heat sink.

8. The light emitting diode of claim 1, wherein the light emitting diode chip is disposed on the cathode, and wherein the anode is disposed on the cathode and has a hole surrounding the light emitting diode chip.

9. The light emitting diode of claim 8, wherein the anode is an anode ring.

10. The light emitting diode of claim 8, wherein the cathode is planar and acts as a heat sink.

11. A printed circuit board having a top surface and a bottom surface, comprising:
at least one light emitting diode having
an anode,
a thermally conductive cathode, wherein the anode and the cathode are electrically isolated from each other,
a light-emitting diode chip disposed on the cathode and electrically coupled to the anode,
a heat sink individually associated with the light emitting diode and integrally coupled to at least one of the anode and the cathode, and
a lens covering the light-emitting diode chip; and
an electrical connection between said at least one light emitting diode and the printed circuit board.

12. The printed circuit board of claim 11, wherein at least one of the anode and the cathode are made from a conductive strip and acts as both a thermal and electrical connector.

13. The printed circuit board of claim 12, wherein at least one of the anode and the cathode is bent and pushed through an opening in the printed circuit board such that a portion of said at least one of the anode and cathode extends below the bottom surface of the printed circuit board.

14. The printed circuit board of claim 13, further comprising a heat equalizer disposed on the top surface of the printed circuit board, wherein at least one of the anode and the cathode is disposed on the heat equalizer.

15. The printed circuit board of claim 11, further comprising a heat equalizer coupled to the anode and the cathode, wherein the heat equalizer acts as an additional heat sink.

16. The printed circuit board of claim 15, wherein the anode and the cathode are disposed on the top surface of the printed circuit board and wherein the heat equalizer has at least one bent portion that extends below the bottom surface of the printed circuit board.

17. The printed circuit board of claim 15, wherein the cathode has at least one lead and an extension, wherein the lead is used to electrically couple the light emitting diode to the printed circuit board.

18. The printed circuit board of claim 17, wherein the extension is coupled to the top surface of the printed circuit board.

19. The printed circuit board of claim 17, wherein the extension is inserted through at least one opening in the printed circuit board to extend below the bottom surface of the printed circuit board.

20. The printed circuit board of claim 17, wherein a first part of the extension portion is coupled to the bottom surface of the printed circuit board such that the lens extends through an opening in the printed circuit board, and wherein a second part of the extension portion extends below the bottom surface of the printed circuit board.

21. The printed circuit board of claim 11, wherein the anode is disposed on the cathode and has a hole surrounding the light emitting diode chip.

22. The printed circuit board of claim 21, wherein the anode is an anode ring, and wherein the anode ring is coupled to the bottom surface of the printed circuit board such that the lens extends through an opening in the printed circuit board.

23. The printed circuit board of claim 21, wherein the cathode is planar and acts as a heat sink.

24. The printed circuit board of claim 23, wherein the cathode is coupled to a system heat sink.

25. The printed circuit board of claim 23, wherein the cathode is coupled to the bottom surface of the printed circuit board such that the lends extends through an opening in the printed circuit board.

26. The printed circuit board of claim 23, wherein the cathode is bent and inserted through at least one opening in the printed circuit board such that a portion cathode extends below the bottom surface of the printed circuit board.
